(19) United States
(12) Patent Application Publication
(10) Pub. No.: US 2015/0078790 A1
(43) Pub. Date: Mar. 19, 2015

(54) DEVELOPING DEVICE, PROCESS CARTRIDGE, AND IMAGE FORMING APPARATUS

(71) Applicants: Yoshimichi ISHIKAWA, Hyogo (JP); Tsuyoshi NOZAKI, Osaka (JP); Tomoharu MIKI, Osaka (JP); Yuta TAKEUCHI, Tokyo (JP); Hideaki YASUNAGA, Tokyo (JP); Keiichiro JURI, Kanagawa (JP)

(72) Inventors: Yoshimichi ISHIKAWA, Hyogo (JP); Tsuyoshi NOZAKI, Osaka (JP); Tomoharu MIKI, Osaka (JP); Yuta TAKEUCHI, Tokyo (JP); Hideaki YASUNAGA, Tokyo (JP); Keiichiro JURI, Kanagawa (JP)

(21) Appl. No.: 14/484,665

(22) Filed: Sep. 12, 2014

(30) Foreign Application Priority Data
Sep. 17, 2013 (JP) 2013-191554

(51) Int. Cl. G03G 15/08

(52) U.S. Cl. CPC G03G 15/0818
USPC 399/286

(57) ABSTRACT

Provided is a developing device, including: a toner having an average circularity of from 0.880 to 0.960; and a developing roller configured to rotate while carrying the toner, wherein the developing roller has on a surface thereof, a plurality of streaky grooves each formed in a circumferential direction, and a plurality of steps each formed in a direction of a rotation axis.

### FIELD OF THE INVENTION

The present invention relates to a developing device, a process cartridge, and an image forming apparatus.

### DESCRIPTION OF THE RELATED ART

For example, image forming apparatuses of a one-component contact development type form a toner image by supplying a toner to an electrostatic latent image on the surface of a photoconductor from a developing roller that is rotating with a toner thin layer formed on the surface thereof. In order to maintain image qualities of such image forming apparatuses, it is necessary to keep the amount of toner charge buildup in the toner thin layer formed on the surface of the developing roller uniform and the toner layer thickness uniform over time. However, in these image forming apparatuses, a regulating member configured to form a toner thin layer, the photoconductor, etc. rotate while making contact with the developing roller via the toner thin layer. Therefore, there are risks of toner filming over the surface of the developing roller or toner adherence to the regulating member. When such toner filming or toner adherence occurs, the toner cannot be supplied to an electrostatic latent image on the surface of the photoconductor uniformly, making it difficult to form high quality images.

Hence, various surface profiles are imparted to the developing roller of a one-component contact development type in order to improve toner conveyability and resettability. For example, there are techniques such as impartment of a complex/minute profile by laser machining, microfabrication by plasma irradiation, impartment of asperity by filler addition, mirror surfacing by polishing/impartment of a longitudinal streak profile in the circumferential direction, and impartment of a transversal streak profile in the longer direction. However, according to the conventional profile pattern impartment techniques, developing rollers with more complex/minute profiles can achieve greater geometric effects (adherence resistance/filming resistance/toner conveyability, etc.), but require greater production costs. Therefore, problematically, there has been poor incentive to employ such developing rollers as developing rollers for one-component contact development, which has been required to be less costly.

Japanese Patent Application Laid-Open (JP-A) No. 06-175476 proposes a developing device that can aim for a long life and maintain toner conveyability for a long term with a developing roller that has on the surface thereof, a corrugated asperity having asymmetric slopes that are recessive against the direction of rotation to thereby reduce friction between the developing roller, the toner, and the photoconductor. However, although this developing device has improved toner conveyability, it is not sufficient in suppression of toner filming over the surface of the developing roller and toner adherence to the regulating member.

### SUMMARY OF THE INVENTION

An object of the present invention is to provide a developing device that is excellent in a toner adherence property, a toner filming property, and toner conveyability.

The problems described above are solved by the invention 1) below.

1) A developing device, including:

a toner having an average circularity of from 0.880 to 0.960; and

a developing roller configured to rotate while carrying the toner,

wherein the developing roller has on a surface thereof, a plurality of streaky grooves each formed in a circumferential direction, and a plurality of steps each formed in a direction of a rotation axis.

The present invention can provide a developing device that is excellent in a toner adherence property, a toner filming property, and toner conveyability.

### BRIEF DESCRIPTION OF THE DRAWINGS

FIG. 1 is a schematic diagram of an example showing an internal configuration of an image forming apparatus.

FIG. 2 is a diagram showing a schematic configuration of an example of a process cartridge.

FIG. 3A is a diagram of an example exemplarily showing a portion of a surface of a developing roller in enlargement.

FIG. 3B is an enlarged image of an example of a groove formed on a surface of a developing roller.

FIG. 3C is an enlarged image of an example of a step formed on a surface of a developing roller.

FIG. 4A is a diagram showing an example of a shape of grooves

FIG. 4B is a diagram showing an example of a shape of steps 112.

### DETAILED DESCRIPTION OF THE INVENTION

The present invention 1) described above will be explained in detail below. Embodiments of the present invention 1) also include the following 2) to 5). These will also be explained together.

2) The developing device according to 1),

wherein the grooves have an average length of from 20 μm to 50 μm in the circumferential direction, the grooves have an average groove depth of from 2 μm to 5 μm, and an average interval between the grooves is from 10 μm to 50 μm.

3) The developing device according to 1) or 2),

wherein the steps have an average length of from 50 μm to 500 μm in the direction of the rotation axis, the steps have an average step height of from 2 μM to 5 μm, and an average interval between the steps is from 50 μm to 200 μm.

4) A process cartridge, including:

the developing device according to any one of 1) to 3), wherein the process cartridge is attachable to and detachable from an apparatus body of an image forming apparatus.

5) An image forming apparatus, including:

the developing device according to any one of 1) to 3).

An example of an embodiment of the present invention will be explained below with reference to the drawings. The same constituent members are denoted with the same reference numerals throughout the drawings.

### <Configuration of Image Forming Apparatus>

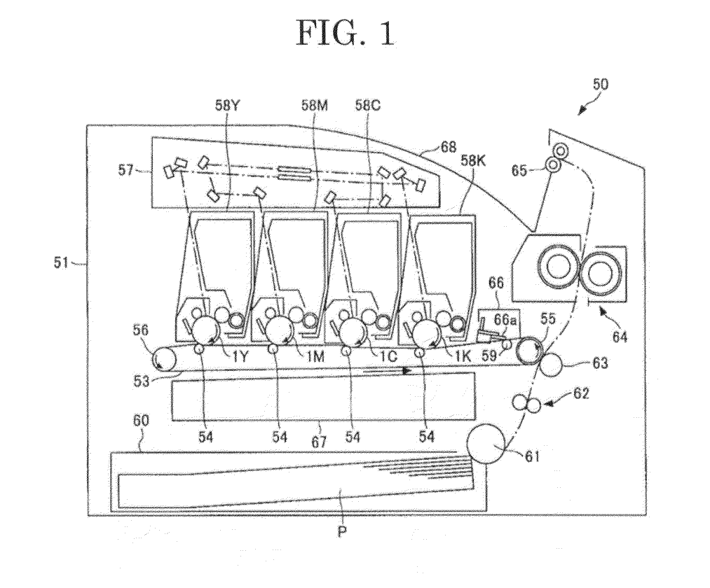

FIG. 1 is a schematic diagram showing an internal configuration of an image forming apparatus 50 of a one-component development type. The image forming apparatus 50 is a color printer, but may be a single-color or color facsimile machine, printer, or multifunction peripheral.

As shown in FIG. 1, the image forming apparatus 50 includes four process cartridges 58K, 58C, 58M, and 58Y that are arranged side by side in the center of a body frame 51. An exposing device 57 configured to form a latent image on photoconductors 1K, 1C, 1M, and 1Y is provided above the process cartridges 58K, 58C, 58M, and 58Y. A black toner image, a cyan toner image, a magenta toner image, and a yellow toner image are formed on the surface of the photoconductors 1K, 1C, 1M, and 1Y respectively.

The process cartridges 58K, 58C, 58M, and 58Y have the same configuration except for using different colors of toners as developers. Therefore, the following explanation will be given by referring to them as process cartridge 58 with abbreviation of the sign representing their color. Likewise, the photoconductors 1K, 1C, 1M, and 1Y will also be referred to as photoconductor 1 with abbreviation of the sign representing their colors.

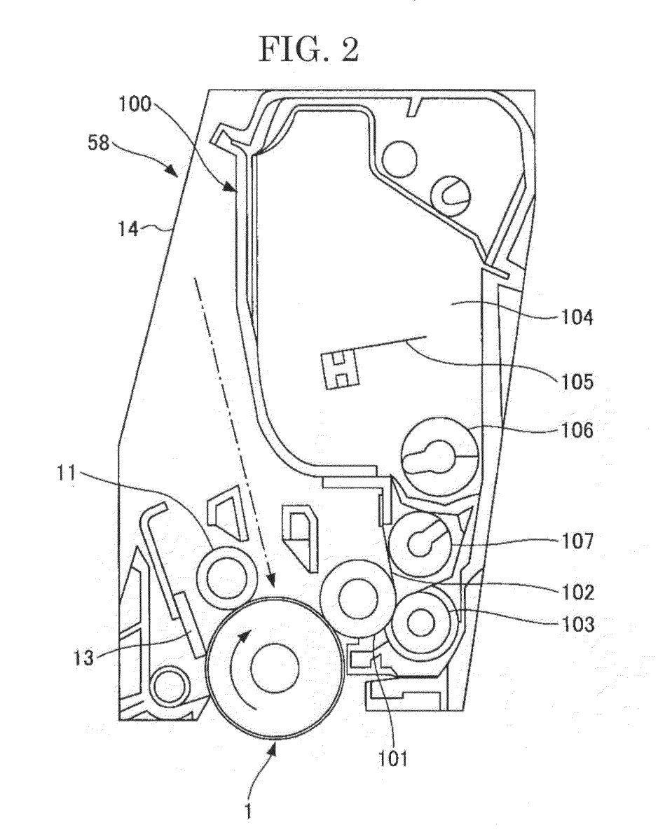

As shown in FIG. 2, the process cartridge 58 includes the photoconductor 1, a charging roller 11, a cleaning blade 13, and a developing device 100 within a frame 14. Via the frame 14, the process cartridge 58 is detachably set in the body frame 51 which is the apparatus body of the image forming apparatus 50.

The charging roller 11 is pressed into contact with the surface of the photoconductor 1, and while being rotated to follow the photoconductor 1 that is driven to rotate, receives a DC bias or an AC-superimposed DC bias applied by an unillustrated high-voltage power supply to thereby electrically charge the surface of the photoconductor 1 to, for example, from −1,000 V to −200 V uniformly.

The developing device 100 includes a developing roller 101, a layer thickness regulating member 102, a feeding roller 103, a toner container 104, a stirring member 105, a stirring/conveying screw 106, and a stirring/conveying screw 107.

A toner contained in the toner container 104 is stirred by the stirring member 105 that is rotated, to be made unaggregated, and in this stated, conveyed to the feeding roller 103 by the stirring/conveying screws 106 and 107. The feeding roller 103 feeds the toner deposited on the surface thereof to the surface of the developing roller 101.

The developing roller 101 rotates while carrying the toner fed by the feeding roller 103. The toner on the surface of the developing roller 101 is regulated to a thin layer by the layer thickness regulating member 102, and formed as an electrically charged toner layer. The developing roller 101 receives a developing bias applied by an unillustrated high-voltage power supply, and forms an electric field between itself and the photoconductor 1 that is in contact with itself via the toner layer, to thereby supply the toner to an electrostatic latent image on the surface of the photoconductor 1 and form a toner image.

With its free end pressed onto the surface of the developing roller 101, the layer thickness regulating member 102 regulates the toner that is passing between the developing roller 101 and the layer thickness regulating member 102 into a thin layer, and imparts charges to the toner by fricative charging.

A developing electric field is formed between the developing roller 101 and the photoconductor 1 to supply the toner from the toner layer on the surface of the developing roller 101 to the electrostatic latent image on the surface of the photoconductor 1, to thereby form a toner image on the surface of the photoconductor 1.

As shown in FIG. 1, an intermediate transfer belt 53 is provided below the process cartridges 58. The intermediate transfer belt 53 is tensed by first transfer rollers 54, a driving roller 55 serving also as an opposite roller for second transfer, an opposite roller 59 for cleaning, and a driven roller 56 serving also as a tension roller, and is rotated as driven by the driving roller 55.

Toner images formed on the surface of the photoconductors 1 are transferred onto the intermediate transfer belt 53 by an electric field formed between the photoconductors and the first transfer rollers 54, and overlaid together on the intermediate transfer belt, to thereby form a color toner image.

A sheet feeding cassette 60 in which sheets P as recording media are stored is provided below the intermediate transfer belt 53. When a sheet P is conveyed for sheet feeding by a sheet feeding roller 61, a conveying roller 62, etc to pass between a second transfer roller 63 and the intermediate transfer belt 53, the toner image on the intermediate transfer belt 53 is second-transferred onto the sheet P. Any transfer residual toner on the surface of the intermediate transfer belt 53 after having transferred the toner image onto the sheet P is scratched away by a blade 66a of a cleaning device 66 and collected into a toner collecting device 67.

The sheet P carrying the toner image on the surface thereof is heated and pressurized when passing through a fixing device 64 to have the toner image fixed on the surface thereof, and then discharged onto a sheet discharging tray 68 of a sheet discharging roller 65.

With the configuration and operation described above, the image forming apparatus 50 prints an image on a sheet P and discharges the sheet P to the outside of the apparatus 50. The image forming apparatus may be configured to directly transfer a toner image onto a sheet P from the photoconductor 1, and is not limited to the configuration of the present embodiment.

### <Surface Configuration of Developing Roller>

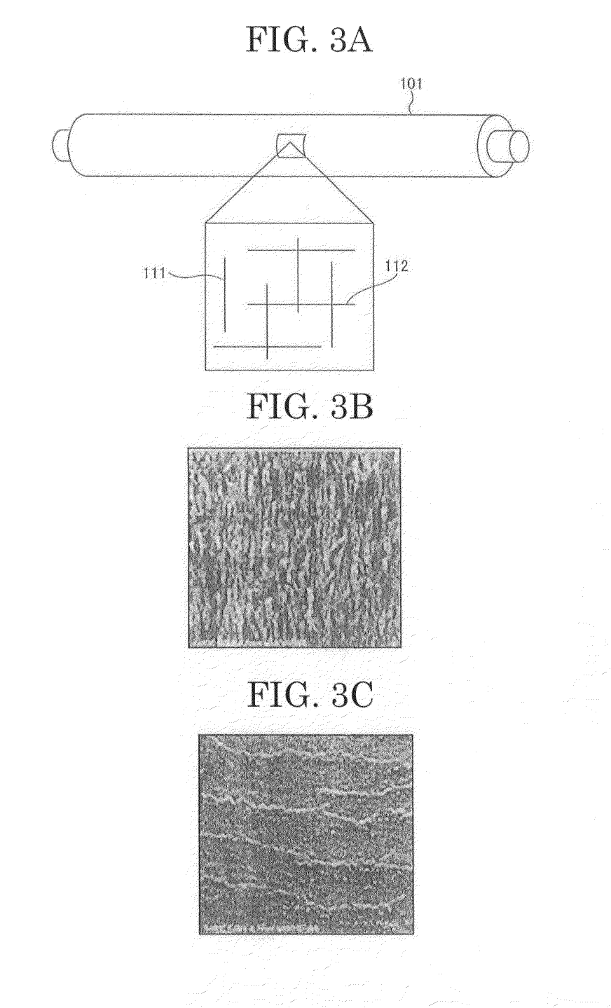

FIG. 3A to FIG. 3C are diagrams showing the surface configuration of the developing roller 101.

FIG. 3A is a diagram exemplarily showing a portion of the surface of the developing roller 101 in enlargement. As shown in this diagram, the developing roller 101 has on the surface thereof, a plurality of streaky grooves 111 each formed in the circumferential direction, and a plurality of steps 112 each formed in the direction of the rotation axis. FIG. 3B is an enlarged image of an example of the grooves 111 formed in the surface of the developing roller 101. FIG. 3C is an enlarged image of an example of the steps 112 formed on the surface of the developing roller 101. The grooves 111 and the steps 112 are formed on the entire surface of the developing roller 101 in a mixed state.

In a one-component development system, a great stress is given to the toner between the developing roller 101 and the layer thickness regulating member 102, between the developing roller 101 and the photoconductor 1, etc., and there are risks of toner adherence to the layer thickness regulating member 102, toner filming over the surface of the developing roller 101, etc.

Particularly, when a low temperature fixable toner is used for energy saving, these risks are increased. Further, when a toner containing a polish is used in order to prevent toner adherence by polishing the layer thickness regulating member 102, the toner has a poor flowability and may cause a solid image followability failure and a toner feeding failure, or the polishing effect may deteriorate to make it impossible to obtain the effect of polishing the layer thickness regulating member 102 and to prevent toner adherence.

With the developing roller 101 of the present embodiment, the grooves 111 formed in the circumferential direction enhance the polishing effect of the polish contained in the toner on the layer thickness regulating member 102, which makes it possible to suppress occurrence of toner adherence.

Further, the steps 112 formed in the direction of the rotation axis can carry the toner supplied by the feeding roller 103 efficiently to the layer thickness regulating member 102, which contributes to improvement of toner conveyability, and makes it possible to cure the solid image followability failure.

Further, with the grooves 111 and the steps 112, the developing roller 101 has an effect of fluidizing the toner in the vicinity of the layer thickness regulating member 102, which makes it possible to suppress occurrence of the toner feeding failure in which the amount of toner fed to the developing region between the developing roller and the photoconductor 1 becomes short.

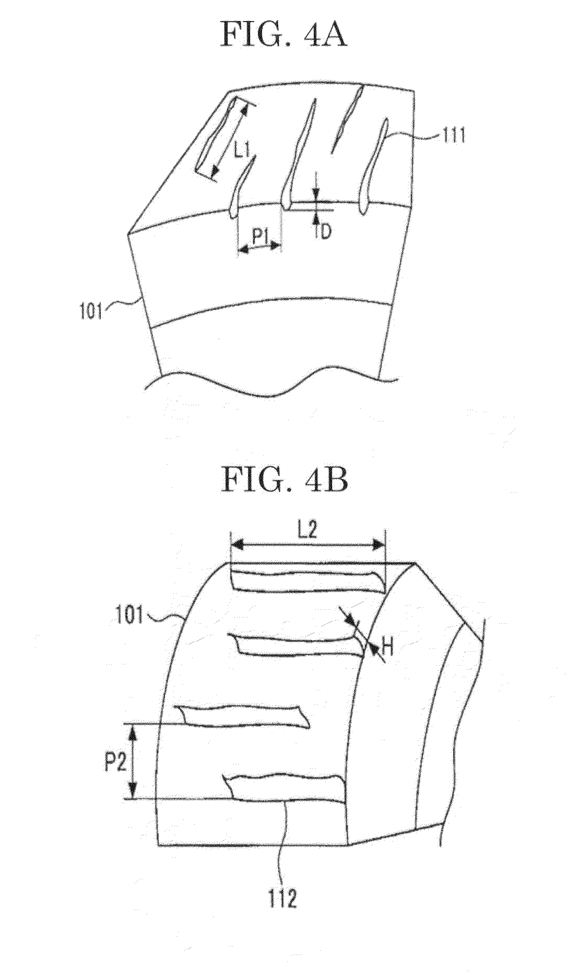

FIG. 4A and FIG. 4B show a schematic configuration of the surface of the developing roller. FIG. 4A is a diagram showing an example of the shape of the grooves 111. FIG. 4B is a diagram showing an example of the shape of the steps 112.

In FIG. 4A, a sign L1 represents the length of the grooves 111 each formed in the circumferential direction of the developing roller 101. The sign D represents the depth of the grooves 111 from the surface of the developing roller 101. The sign P1 represents the interval (pitch) between grooves 111 that adjoin each other in the direction of the rotation axis on the surface of the developing roller 101.

The average length L1 of the grooves 111 is preferably from 20 μm to 50 μm, and more preferably from 30 μm to 40 μm. The average depth D thereof is preferably from 2 μm to 5 μm, and more preferably from 3 μm to 4.5 μm. The average pitch P1 is preferably from 10 μm to 50 μm, and more preferably from 20 μm to 40 μm. Having asperity suitable for the toner particle diameter on the surface, the developing roller 101 gives a motion energy to the toner to increase chances of contact with the developing roller 101, and to thereby produces an effect of stabilizing the amount of charge buildup in the toner.

In FIG. 4B, the sign L2 represents the length of the steps 112 each formed in the direction of the rotation axis of the developing roller 101. The sign H represents the height of the steps 112 from the surface of the developing roller 101. The sign P2 represents the interval (pitch) between steps 112 that adjoin each other in the circumferential direction on the surface of the developing roller 101.

The average length L2 of the grooves 112 is preferably from 50 μm to 500 μm, and more preferably from 100 μm to 300 μm. The average height H thereof is preferably from 2 μm to 5 μm, and more preferably from 3 μm to 4.5 μm. The average pitch P2 is preferably from 50 μm to 200 μm, and more preferably from 80 μm to 180 μm.

Further, in the present invention, a toner with a lower average circularity than conventional, namely from 0.880 to 0.960 is used. The average circularity is preferably from 0.880 to 0.945, and more preferably from 0.890 to 0.935. When the average circularity is less than 0.880, the conveyability of the toner by the developing roller is high, and the toner may be fed more than necessary and may cause background smear due to shortage of charge buildup. When the average circularity is greater than 0.960, an intended rolling motion suppression may not be obtained sufficiently, and toner adherence may occur at the end of the developing roller.

Further, it is also possible to cure toner feeding failure by using the toner having the low circularity. Toner feeding failure is a phenomenon in which because of shortage of toner feeding from a toner feeding paddle, the toner density becomes thinner in a folding fan fashion toward the rear end of a solid image while the solid image is being collected. The reason why the toner feeding failure is cured even though the amount of toner feeding from the paddle remains unchanged is uncertain. However, it is considered that rotation of the developing roller having great height differences due to the streaky grooves and the steps promotes fluidization of the toner in the region in front of the regulating member, and consequently increases the amount of toner to accompany to be delivered to the regulating member.

Then, it is considered that by combining the developing roller having the specific configuration described above with the low circularity toner, it is possible to make it harder for the toner to roll on the surface of the roller, and particularly to suppress the toner from rolling down to an end to which it tends to accumulate unevenly, which leads to elimination of adherence to the end.

### Examples

The present invention will be explained below in more detail based on Examples and Comparative Examples. The present invention is not limited to these Examples. In the Examples, “part” means “part by mass”.

### <Production of Developing Roller 1>

An epichlorohydrin rubber HYDRIN T3106 manufactured by Zeon Corporation was extruded onto a metal shaft made of SUM and having a diameter of 6 mm to have a rubber thickness of 3 mm. After this, the resultant was stored at 150° C. for 120 minutes, and then vulcanized. Then, the surface of the roller was lapped with a polishing machine LE0600-F4L-BME manufactured by Minakuchi Machinery Works Ltd. until the surface roughness Ra became 1.0 μm, and then finish-polished with SZC manufactured by Minakuchi Machinery Works Ltd. under conditions: tape roughness of 20 μm; a rubber roller rotation speed of 800 rpm; 2 pass polishing; a tape forwarding speed of 25 mm/s; with oscillation; and a traverse forwarding speed of 700 mm/s, to thereby obtain a rubber base member of a developing roller.

Meanwhile, ISOCYANATE D170N manufactured by Mitsui Chemicals Polyurethanes Inc. (2.5 parts) and KETJEN BLACK EC manufactured by Ketjen Black International Company (0.03 parts) were added to ethyl acetate (100 parts), and they were stirred for 60 minutes with a Turbula mixer manufactured by Shinmaru Enterprises Corporation, to thereby obtain a surface layer material.

Next, this surface layer material was applied over the rubber base member of a developing roller to have a film thickness of 2.0 μm by spraying with AM6 TYPE NOZZLE manufactured by Atomax Chemicals Co. Ltd. by 2 passes, and then calcinated at 150° C. for 1 hour, to thereby obtain a developing roller 1.

### <Production of Developing Roller 2>

A developing roller 2 was obtained in the same manner as in Example 1, except that the tape roughness for finish polishing was changed to 25 μm.

### <Production of Developing Roller 3>

A developing roller 3 was obtained in the same manner as in Example 1, except that the tape roughness for finish polishing was changed to 30 μm.

### <Production of Developing Roller 4>

A developing roller 4 was obtained in the same manner as in Example 1, except that the number of passes for spray application of the surface layer material was changed to 1.

### <Production of Developing Roller 5>

A developing roller 5 was obtained in the same manner as in Example 1, except that the number of passes for spray application of the surface layer material was changed to 3.

### <Production of Developing Roller 6>

A developing roller 6 was obtained in the same manner as in Example 1, except that the surface roughness Ra to be obtained after lapping was changed to 1.5 μm.

### <Production of Developing Roller 7>

A developing roller 7 was obtained in the same manner as in Example 1, except that the surface roughness Ra to be obtained after lapping was changed to 0.6 μm.

### <Production of Developing Roller 8>

An epichlorohydrin rubber HYDRIN T3106 manufactured by Zeon Corporation was extruded onto a metal shaft made of SUM and having a diameter of 6 mm to have a rubber thickness of 3 mm. After this, the resultant was stored at 150° C. for 120 minutes, and then vulcanized. Then, the surface of the roller was lapped with a polishing machine LEO600-F4L-BME manufactured by Minakuchi Machinery Works Ltd. until the surface roughness Ra became 1.0 μm, to thereby obtain a rubber base member of a developing roller.

Then, a surface layer was produced in the same manner as in Example 1, to thereby obtain a developing roller 8.

### <Production of Developing Roller 9>

A developing roller 9 was obtained in the same manner as in Example 1, except that the number of passes for finish polishing was changed to 4 (4 pass polishing).

<Measurement of Surface Roughness Ra of Roller Surface after Lapping>

The surface roughness Ra of the roller surface after lapping was measured with SURFCOM 1400D manufactured by Tokyo Seimitsu Co., Ltd. at a measurement speed of 0.3 mm/s, at a measurement length of 4.0 mm, with a cutoff wavelength of 0.8 mm, at a measurement magnification of ×2.0, at a λs cutoff ratio of 300, and at a λs cutoff wavelength of 2.6667 μm. The surface roughness Ra was calculated according to JIS-'01 standard.

### <Measurement of Profiles of Grooves 111 and Steps 112 of Developing Roller>

The length L1 and pitch P1 of the grooves 111, and the length L2 and pitch P2 of the steps 112 of the developing roller were measured as follows.

First, with a scanning electron microscope S-4800 manufactured by Hitachi High-Tech Manufacturing & Service Corporation, five positions (axial direction both ends, an axial direction center, and two intermediate positions between the ends and the center) of the surface of the developing roller were imaged at a magnification of ×2,000. Then, from each of the surface images of the five positions, ten grooves 111 and ten steps 112 were extracted, and the length L1 and pitch P1 of the grooves 111 and the length L2 and pitch P2 of the steps 112 were measured. The averages of the measurements were regarded as the length L1 and pitch P1 of the grooves 111 and the length L2 and pitch P2 of the steps 112.

The depth D of the grooves 111 of the developing roller was measured as follows.

First, the developing roller was sectioned in its axial direction. Next, with a scanning electron microscope S-4800 manufactured by Hitachi High-Tech Manufacturing & Service Corporation, five positions (axial direction both ends, an axial direction center, and two intermediate positions between the ends and the center) of the cross-sectional surface of the developing roller were imaged at a magnification of ×2,000. Next, from each of the cross-sectional images of the five positions, ten grooves 111 were extracted, and the depth thereof was measured. The average of the measurements was regarded as the depth D of the grooves 111.

The height H of the steps 112 of the developing roller was measured as follows.

First, the developing roller was sectioned at five positions (axial direction both ends, an axial direction center, and two intermediate positions between the ends and the center) in a direction orthogonal to the axial direction thereof. Next, with a scanning electron microscope S-4800 manufactured by Hitachi High-Tech Manufacturing & Service Corporation, the cross-sectional surfaces of the five positions were imaged at a magnification of ×2,000. Next, from each of the cross-sectional images of the five positions, ten steps 112 were extracted, and the height thereof was measured. The average of the measurements was regarded as the height H of the steps 112.

The production conditions of each of the developing rollers above, and the profiles of the grooves 111 and steps 112 are shown in Table 1 collectively.

### <Production of Toner 1>

### [Production of First Binder Resin]

A dropping funnel was charged with vinyl-based monomer styrene (600 g), butyl acrylate (110 g), and acrylic acid (30 g), and further with dicumyl peroxide (30 g) as a polymerization initiator.

Next, a 5-liter four-necked flask equipped with a thermometer, a stirrer made of stainless, a flux capacitor, and a nitrogen introducing pipe was charged with polyoxypropylene (2.2)-2,2-bis(4-hydroxyphenyl)propane (1,230 g), polyoxyethylene (2.2)-2,2-bis(4-hyroxyphenyl)propane (290 g), isododecenyl succinic anhydride (250 g), terephthalic acid (310 g), 1,2,4-benzene tricarboxylic anhydride (180 g), dibutyl tin oxide (7 g) as an esterification catalyst, and as a wax, a paraffin wax (with a melting point of 73.3° C., and an endothermic peak half value width of 4° C. measured with a differential scanning calorimeter during temperature raising) (4 parts by mass relative to 100 parts by mass of the monomers charged).

Next, while the materials in the four-necked flask were stirred in a mantle heater under a nitrogen atmosphere at 160° C., the mixture liquid of the materials in the dropping funnel was dropped thereinto in 1 hour.

Then, with the temperature retained at 160° C., the materials were let to undergo an addition polymerization reaction for 2 hours and aged, and after this, let to undergo a condensation polymerization reaction with the temperature raised to 230° C.

The degree of polymerization was kept track of based on softening points measured with a constant load extrusion narrow tube rheometer, and the reaction was terminated when a desired softening point was reached, to thereby obtain a first binder resin. The softening point of this resin was 130° C.

### [Production of Second Binder Resin]

A 5-liter four-necked flask equipped with a thermometer, a stirrer made of stainless, a flux capacitor, and a nitrogen introducing pipe was charged with polyoxypropylene (2.2)-2,2-bis(4-hydroxyphenyl)propane (2,210 g), terephthalic acid (850 g), 1,2,4-benzene tricarboxylic anhydride (120 g), and dibutyl tin oxide (0.5 g) as an esterification catalyst, and the materials were let to undergo a condensation polymerization reaction in a mantle heater under a nitrogen atmosphere with the temperature raised to 230° C.

The degree of polymerization was kept track of based on softening points measured with a constant load extrusion narrow tube rheometer, and the reaction was terminated when a desired softening point was reached, to thereby obtain a second binder resin. The softening point of this resin was 115° C.

### [Production of Colorant Resin Particles 1]

A master batch containing 4 parts of C.I. Pigment Red 57-1 relative to 100 parts (including the weight of an internal additive wax) of binder resins including: 60 parts of the first binder resin; and 40 parts of the second binder resin was mixed sufficiently with a Henschel mixer, and then melt-kneaded with a biaxial extruder kneader (PCM-30: manufactured by Ikegai Corp.). The obtained kneaded product was rolled with a cooling press roller to a thickness of 2 mm, cooled with a cooling belt, and then coarsely pulverized with a feather mill.

After this, the obtained product was pulverized with a mechanical pulverizer (KTM manufactured by Kawasaki Heavy Industries, Ltd.) to a volume average particle diameter of from 10 μm to 12 μm, and then pulverized with a jet pulverizer (IDS manufactured by Nippon Pneumatic Mfg. Co., Ltd.) with coarse particles classification. After this, fine particle classification was performed with a rotor classifier (TEEPLEX CLASSIFIER TYPE 100ATP manufactured by Hosokawa Micron K.K.), to thereby obtain colorant resin particles 1 having a volume average particle diameter of 8.1 μm and an average circularity of 0.878.

### [Shape Control Step] (Production of Toner Base 1)

The colorant resin particles 1 were processed with surface modification equipment (MR-10 manufactured by Nippon Pneumatic Mfg. Co., Ltd.) at a feeding rate of 2.0 kg/hr and a hot air temperature of 170° C., to thereby obtain a toner base 1 having an average circularity of 0.905.

### [External Addition Step]

As an external additive, silica (1.2 parts) was added to 100 parts of the toner base 1, and they were mixed with a Henschel mixer to thereby obtain a toner 1.

### <Production of Toner 2>

A toner 2 having an average circularity of 0.881 was obtained in the same manner as in <Production of Toner 1>, except that the hot air temperature in [Shape Control Step] was changed to 140° C.

### <Production of Toner 3>

A toner 3 having an average circularity of 0.931 was obtained in the same manner as in <Production of Toner 1>, except that the hot air temperature in [Shape Control Step] was changed to 205° C.

### <Production of Toner 4>

A toner 4 having an average circularity of 0.959 was obtained in the same manner as in <Production of Toner 1>, except that the hot air temperature in [Shape Control Step] was changed to 240° C.

### <Production of Toner 5>

A toner 5 having an average circularity of 0.878 was obtained in the same manner as in <Production of Toner 1>, except that [Shape Control Step] was skipped.

### <Production of Toner 6]

A toner 6 having an average circularity of 0.963 was obtained in the same manner as in <Production of Toner 1>, except that the hot air temperature in [Shape Control Step] was changed to 245° C.

### Examples 1 to 10 and Comparative Examples 1 to 4

The developing rollers and toners above were combined as shown in the fields of the respective Examples and Comparative Examples of Table 2, set in IPSIO-C310 manufactured by Ricoh Company Limited, and evaluated in the following points. The results are shown in Table 2 collectively.

### <Toner Adherence>

After running on 10,000 sheets at a temperature of 30° C., at a humidity of 80% RH, and in a blank sheet durable one sheet intermittent mode, a half-tone image with a printing rate of 25% was output, and the number of longitudinal white streaks in the image was checked visually, and evaluated based on the criteria below.

### [Evaluation Criteria]

A: The number of produced white streaks was 0.

B: The number of produced white streaks was 1.

C: The number of produced white streaks was 2 or greater.

### <Solid Image Followability>

After running on 10,000 sheets at a temperature of 30° C., at a humidity of 80% RH, and in a blank sheet durable one sheet intermittent mode, two black solid images were output continuously. The density of the black solid image at the rear end of the second sheet was measured with a Macbeth Transmission Reflection Densitometer (RD-918 manufactured by GretagMacbeth Corporation), and evaluated based on the criteria below.

### [Evaluation Criteria]

A: 1.45 or greater

B: 1.35 or greater but less than 1.45

C: Less than 1.35

### <Toner Feeding Property>

After running on 10,000 sheets at a temperature of 30° C., at a humidity of 80% RH, and in a blank sheet durable one sheet intermittent mode, black solid images were output continuously. Density decreasing that fanned out toward the rear end of the images was checked. That is, the density of the black solid image at the rear end of the images was measured with a Macbeth Transmission Reflection Densitometer (RD-918 manufactured by GretagMacbeth Corporation), and evaluated based on the criteria below.

### [Evaluation Criteria]

A: 1.45 or greater

B: 1.35 or greater but less than 1.45

C: Less than 1.35

### <Toner Filming>

After running on 10,000 sheets at a temperature of 30° C., at a humidity of 80% RH, and in a blank sheet durable one sheet intermittent mode, the surface of the developing roller was checked with a SEM (a scanning electron microscope manufactured by Hitachi Ltd.). That is, toner filming was evaluated based on the criteria below, according to presence or absence of toner on the surface of the developing roller after it was blown with air.

### [Evaluation Criteria]

A: Almost no toner was deposited on the surface of the developing roller.

B: The surface profile of the developing roller was partially changed, although deposited toner partially came off.

C: The toner could not come off with air blowing, and the surface of the developing roller was changed.

TABLE 1

| | Tape | Number | | | | | | | |
|---|---|---|---|---|---|---|---|---|---|
| | roughness | of passes | Ra | | | | | | |
| | for finish | for spray | after | Grooves (μm) | | | Steps (μm) | | |
| | polishing | appli- | lapping | Length | Depth | Pitch | Length | Height | Pitch |
| | (μm) | cation | (μm) | L1 | D | P1 | L2 | H | P2 |
| Developing | 20 | 2 | 1.0 | 22 | 3.3 | 41 | 200 | 4.6 | 90 |
| roller 1 | | | | | | | | | |
| Developing | 25 | 2 | 1.0 | 26 | 3.3 | 44 | 200 | 4.1 | 90 |
| roller 2 | | | | | | | | | |
| Developing | 30 | 2 | 1.0 | 31 | 3.3 | 48 | 200 | 3.2 | 90 |
| roller 3 | | | | | | | | | |
| Developing | 20 | 1 | 1.0 | 22 | 4.5 | 41 | 200 | 4.9 | 90 |
| roller 4 | | | | | | | | | |
| Developing | 20 | 3 | 1.0 | 22 | 2.6 | 41 | 200 | 2.2 | 90 |
| roller 5 | | | | | | | | | |
| Developing | 20 | 2 | 1.5 | 22 | 3.3 | 41 | 200 | 5.0 | 90 |
| roller 6 | | | | | | | | | |
| Developing | 20 | 2 | 0.6 | 22 | 3.3 | 41 | 200 | 2.0 | 90 |
| roller 7 | | | | | | | | | |
| Developing | — | 2 | 1.0 | None | None | None | 200 | 8.4 | 90 |
| roller 8 | | | | | | | | | |
| Developing | 20 | 2 | 1.0 | 22 | 8.6 | 42 | None | None | None |
| roller 9 | | | | | | | | | |

TABLE 2

| | | | | | Toner | |
|---|---|---|---|---|---|---|
| | Developing | | Toner | Solid image | feeding | Toner |
| | roller | Toner | adherence | followability | property | filming |
| Ex. 1 | 1 | 1 | A | A | A | A |
| Ex. 2 | 2 | 1 | A | A | A | A |
| Ex. 3 | 3 | 1 | A | A | A | A |
| Ex. 4 | 4 | 1 | A | A | A | A |
| Ex. 5 | 5 | 1 | A | A | A | A |
| Ex. 6 | 6 | 1 | A | A | A | A |
| Ex. 7 | 7 | 1 | A | A | A | A |
| Ex. 8 | 1 | 2 | A | A | B | A |
| Ex. 9 | 1 | 3 | A | A | A | A |
| Ex. 10 | 1 | 4 | B | A | A | A |
| Comp. | 8 | 1 | B | A | C | C |
| Ex. 1 | | | | | | |
| Comp. | 9 | 1 | A | C | B | C |
| Ex. 2 | | | | | | |
| Comp. | 1 | 5 | A | A | C | B |
| Ex. 3 | | | | | | |
| Comp. | 1 | 6 | C | B | A | A |
| Ex. 4 | | | | | | |

This application claims priority to Japanese application No. 2013-191554, filed on Sep. 17, 2013 and incorporated herein by reference.

What is claimed is:

1. A developing device, comprising:
a toner having an average circularity of from 0.880 to 0.960; and
a developing roller configured to rotate while carrying the toner,
wherein the developing roller has on a surface thereof, a plurality of streaky grooves each formed in a circumferential direction, and a plurality of steps each formed in a direction of a rotation axis.

2. The developing device according to claim 1,
wherein the grooves have an average length of from 20 μm to 50 μm in the circumferential direction,
wherein the grooves have an average groove depth of from 2 μm to 5 μm, and
wherein an average interval between the grooves is from 10 μm to 50 μm.

3. The developing device according to claim 1,
wherein the steps have an average length of from 50 μm to 500 μm in the direction of the rotation axis,
wherein the steps have an average step height of from 2 μm to 5 μm, and
wherein an average interval between the steps is from 50 μm to 200 μm.

4. The developing device according to claim 2,
wherein the steps have an average length of from 50 μm to 500 μm in the direction of the rotation axis,
wherein the steps have an average step height of from 2 μm to 5 μm, and
wherein an average interval between the steps is from 50 μM to 200 μm.

5. A process cartridge, comprising:
the developing device according to claim 1,
wherein the process cartridge is attachable to and detachable from an apparatus body of an image forming apparatus.

6. An image forming apparatus, comprising:
the developing device according to claim 1.
